(19) United States
(12) Patent Application Publication
(10) Pub. No.: US 2009/0169098 A1
(43) Pub. Date: Jul. 2, 2009

(54) Image quality estimation device and method

(76) Inventors: Jong-Ho Chong, Suwon-si (KR); Seung-Bae Lee, Suwon-si (KR); Jae-Woo Bae, Suwon-si (KR); Sang-Ho Kim, Suwon-si (KR); Hun-Soo Kim, Suwon-si (KR)

Correspondence Address: CHRISTIE, PARKER & HALE, LLP, PO BOX 7068, PASADENA, CA, 91109-7068, US

(21) Appl. No.: 12/217,598

(22) Filed: Jul. 3, 2008

(30) Foreign Application Priority Data
Dec. 26, 2007 (KR) 10-2007-0137422

(51) Int. Cl. G06K 9/00

(52) U.S. Cl. 382/162

(57) ABSTRACT

The present invention relates to an image quality evaluating device for using a color appearance model to evaluate image quality of a color area, and a method thereof. The image quality evaluating device realizes a color space corresponding to a color area by using information on color appearance, calculating a volume of the color space, and calculating clearness of the color area, viewing angle characteristics, gray level characteristics, and color differences in the color space.

### CROSS-REFERENCE TO RELATED APPLICATION

This application claims priority to and the benefit of Korean Patent Application No. 10-2007-0137422 filed in the Korean Intellectual Property Office on Dec. 26, 2007, the entire contents of which are incorporated herein by reference.

### BACKGROUND OF THE INVENTION

1. Field of the Invention

The present invention relates to an evaluating device for evaluating image quality of an image display device, and a method thereof.

2. Description of the Related Art

In a conventional image quality evaluating method of an image display device, image quality is obtained by physically measuring and analyzing light obtained from an image rather than evaluating quality of an image perceived by a user. For example, factors for estimating image quality include contrast ratio, luminance, and color gamut, and the factors are used to represent a level of image quality of the image display device.

However, the levels obtained by using these factors are different from colors perceived by a user. In addition, the colors perceived by the user according to external environment conditions (e.g., illuminant, and background and surrounding colors) may not have a linear relationship with the physically represented levels.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments according to the present invention provide an image quality evaluating device for standardizing image quality perceived by a person, and a method thereof. According to the exemplary embodiments, an evaluating device and method for evaluating color reproduction capability of an image display device, is provided. The evaluating device evaluates the image quality of the image display device based on a result obtained by user's perception of a display image.

According to an exemplary embodiment of the present invention, an image quality evaluating device for evaluating image quality of a color area by using a color appearance model includes a chromatic adaptation unit, a dynamic adaptation unit, a calculator, and a color appearance predictor. The chromatic adaptation unit generates a chromatic adaptation result for the color area. The dynamic adaptation unit receives the chromatic adaptation result and generates a lightness adaptation result with respect to the color area. The calculator uses the lightness adaptation result to calculate information on color appearance of the color area. The color appearance predictor uses the information on the color appearance to realize a color space corresponding to the color area, calculates a volume of the color space, and calculates clearness of the color area, viewing angle characteristics, gray level characteristics, and color differences in the color space.

The information on the color appearance may include brightness, colorfulness, and a hue angle of the color area.

The color appearance predictor may include a color space realizing unit for forming a color space by moving a position by the brightness in a direction perpendicular to a plane including the position and a reference line, and calculating a volume of the color space. The position is determined by rotating the reference line having a radius of the colorfulness by the hue angle.

The color space realizing unit may add respective volumes of a plurality of triangular pyramids to calculate a volume of the color space, and each triangular pyramid may include three points that are closest to a point of the color space and the point.

The number of points used to determine the volume of the color space may be at least ¼ of all the points forming the color space.

The color appearance predictor may further include a definition determining unit for calculating a ratio of a maximum value and a minimum value of the brightness in the color space, and calculate clearness of the color area according to the calculated ratio.

The maximum value may correspond to a brightness of a white level, and the minimum value may correspond to a brightness of a black level.

The color appearance predictor may further include a viewing angle characteristic determining unit for calculating the color space volume according to the hue angle, and calculating viewing angle characteristics of the color area.

The color appearance predictor may further include a gray level calculator for detecting a plurality of points of the color area with respect to a plurality of color stimulus values in which gray levels are different in the color area, and generating paths connecting the plurality of points according to gray level variations.

The color appearance predictor may further include a color difference calculator for diversifying an externally exposed condition of the color area to detect a plurality of points of the color space corresponding to an object area of the color area, and calculating a color difference according to an externally exposed condition of the object area.

According to an exemplary embodiment of the present invention, in an image quality evaluating method using a color appearance model to evaluate image quality of a color area, a chromatic adaptation result with respect to the color area is generated, the chromatic adaptation result is received, a lightness adaptation result with respect to the color area is generated, the lightness adaptation result is used to calculate information on color appearance of the color area, and color appearance characteristics are generated by using the information on the color appearance to realize a color space corresponding to the color area, calculating a volume of the color space, and calculating clearness of the color area, viewing angle characteristics, gray level characteristics, and color differences in the color space.

The information on the color appearance may include brightness, colorfulness, and a hue angle of the color area.

When the color appearance characteristics are generated, a color space may be formed by moving a position by the brightness in a direction perpendicular to a plane including the position and a reference line, and a volume of the color space may be calculated. The position is determined by rotating the reference line having a radius of the colorfulness by the hue angle.

When the volume of the color space is calculated, respective volumes of a plurality of triangular pyramids may be added to calculate a volume of the color space, and each triangular pyramid may include three points that are closest to a point of the color space and the point.

The number of points to measure the volume of the color space may be at least ¼ of all the points forming the color space.

When the color appearance characteristics are generated, a ratio of a maximum value and a minimum value of the brightness in the color space may be calculated, and clearness of the color area may be calculated according to the calculated ratio.

The maximum value may correspond to a brightness of a white level, and the minimum value may correspond to a brightness of a black level.

When the color appearance characteristics are generated, the color space volume may be calculated according to the hue angle, and viewing angle characteristics of the color area may be calculated.

When the color appearance characteristics are generated, a plurality of points of the color area with respect to a plurality of color stimulus values in which gray levels may be different in the color area, and paths connecting the plurality of points according to gray level variations may be generated.

When the color appearance characteristics are generated, an externally exposed condition of the color area may be diversified to detect a plurality of points of the color space corresponding to an object area of the color area, and a color difference according to an externally exposed condition of the object area may be calculated.

According to the exemplary embodiment of the present invention, the image quality evaluating device for calculating data with respect to an image perceived by a person, and an image quality evaluating method, are provided.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram of an image quality evaluating device according to an exemplary embodiment of the present invention.

FIG. 2 is a diagram of a color appearance predictor according to the exemplary embodiment of the present invention.

FIG. 3 is a diagram of a location corresponding to one color stimulus (X,Y,Z) in a JCh coordinate.

FIG. 4 is a color diagram of a color space realized on the JCh coordinate.

FIG. 5 is a diagram of a position corresponding to one color stimulus (X,Y,Z) in a QMh coordinate.

FIG. 6 is a color diagram of the color space realized on the QMh coordinate.

FIG. 7 is a diagram representing a method for calculating a color space volume.

FIG. 8 is a table representing volumes of color spaces according to respective grayscales and a ratio between color space volumes according to the respective grayscales and the color space volume of the 256 grayscale.

FIG. 9 is a graph representing results shown in FIG. 8.

FIG. 10A is a color image that shows a color area of a conventional two-dimensional plane, in which color areas of an image display device D1 and an image display device D2 according to the CIELUV suggested in 1976 are shown.

FIG. 10B shows the color space volumes of the image display devices D1 and D2 according to the QMh coordinate that are realized by the color space realizing unit 410 according to the exemplary embodiment of the present invention.

FIG. 11 shows color spaces of the QMh coordinate of image display devices D3 and D4 according to the exemplary embodiment of the present invention.

FIG. 12 is a color diagram representing the color space volumes at hue angles of 0°, 30°, and 60° in the color space of the QMh coordinate by a viewing angle characteristic determining unit according to the exemplary embodiment of the present invention.

FIG. 13 is a table of the color space volumes in FIG. 12.

FIG. 14 is a color diagram representing paths connecting detected points in the color space of the QMh coordinate.

FIG. 15A shows color images in different conditions.

FIG. 15B shows color distribution of an area in the color space of the QMh coordinate that is perceived in different conditions by a person.

### DETAILED DESCRIPTION OF THE EMBODIMENTS

In the following detailed description, only certain exemplary embodiments of the present invention have been shown and described, simply by way of illustration.

Throughout this specification and the claims that follow, unless explicitly described to the contrary, the word “comprise” and variations such as “comprises” or “comprising” will be understood to imply the inclusion of stated elements but not the exclusion of any other elements.

An image quality evaluating device according to an exemplary embodiment of the present invention and an evaluating method thereof will now be described with reference to the figures.

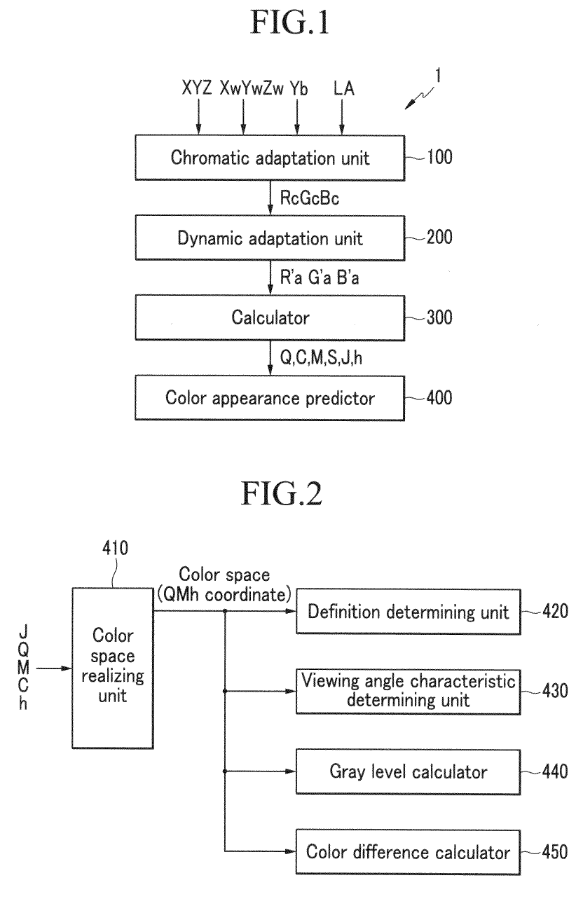

FIG. 1 is a diagram of an image quality evaluating device according to an exemplary embodiment of the present invention.

The image quality evaluating device according to the exemplary embodiment of the present invention adopts the CIE color appearance model 2002 (CIECAM02) to evaluate image quality of an image display device. A color appearance model is used to predict color appearance variations of color stimulus by diversifying conditions under which a person is exposed to an external stimulus. Color appearance is an actual color perceived by the user. That is, the color appearance model in the exemplary embodiment of the present invention is used to determine whether the user perceives color stimulus of a display image of an image display device as a predetermined color appearance space.

As shown in FIG. 1, an image quality evaluating device 1 includes a chromatic adaptation unit 100, a dynamic adaptation unit 200, a calculator 300, and a color appearance predictor 400. The image quality evaluating device 1 receives tristimulus values X, Y, and Z of a color area on which an image as an object for image quality evaluation is displayed, reference white tristimulus values Xw, Yw, and Zw, a relative luminance Yb of a color background neighboring the color area of the object image, and an adapting field luminance L_{A}. Generally, the adapting field luminance L_{A} is established to be 20% of a white object luminance in a scene and inputted.

In addition, in the image quality evaluating device 1, context parameters include contrast factors F and Nc, and an exponential non-linear factor c. The contrast factors are determined according to luminance difference between the color area and surroundings, and the exponential non-linear coefficient c is used to modulate a brightness of the color area that is generated by a lightness of a background and response compression of a colorfulness. The contrast factors F and Nc and the exponential non-linear coefficient c may vary according to image display environments, and are established as average, dim, and dark.

The chromatic adaptation unit 100 converts the tristimulus values X, Y, and Z to be values corresponding to color appearance perceived by a user according to chromatic adaptation to generate a chromatic adaptation result. The chromatic adaptation is one aspect of vision that may fool someone into observing a color-based optical illusion. By way of example, because of chromatic adaptation a person may become less sensitive to a certain color when he becomes used to that color. The chromatic adaptation unit 100 applies the tristimulus values X, Y, and Z and the reference white tristimulus values Xw, Yw, and Zw to the same transformation matrix to generate R, G, and B response values and reference R, G, and B response values as spectrally cone response values. An M_{CAT02} matrix used in the CIECAM02 is used as the transformation matrix in the exemplary embodiment of the present invention. The M_{CAT02} matrix is normalized to generate the spectrally cone response values R, G, and B having the same tristimulus values (X=Y=Z=100) for the same energy light source, which is given as Equation 1.

$$\vert \begin{matrix}R \\ G \\ B\end{matrix} \vert = {M}_{CAT 02} \vert \begin{matrix}X \\ Y \\ Z\end{matrix} \vert \qquad Equation 1$$

Here, an M_{CAT02} matrix is given as Equation 2.

$${M}_{CAT 02} = \vert \begin{matrix}0.7328 & 0.4296 & - 0.1624 \\ - 0.7036 & 1.6975 & 0.0061 \\ 0.0030 & 0.0136 & 0.9834\end{matrix} \vert \qquad Equation 2$$

An adaptation factor D indicates an adaptation level, and is converged to a limitation value of 1 as the color area reflects more than a light emitting level. The luminance adaptation factor D may be expressed as a function of the adapting field luminance L_{A} and the contrast factor F, which is given as Equation 3. When assuming that a light source is omitted, the adaptation factor D is established to be 1. The adaptation factor D has a range between 1 indicating complete adaptation and 0 indicating no adaptation.

$$D = F [ 1 - ( \frac{1}{3.6} ) {e}^{( \frac{- {L}_{A} - 42}{92} )} ] \qquad Equation 3$$

When the adaptation factor D is established, the chromatic adaptation unit 100 calculates the R, G, and B response values for the tristimulus values X, Y, and Z to be adapted tristimulus response values Rc, Gc, and Bc, and calculates the reference R, G, and B response values Rw, Gw, and Bw to be adapted reference tristimulus response values Rwc, Gwc, and Bwc. The R response value Rc of the adapted tristimulus response values Rc, Gc, and Bc correlates to the reference R response Rw of the reference R, G, and B response values Rw, Gw, and Bw, the G response value Gc correlates to the reference G response value Gw, and the B response value Bc correlates to the reference B response value Bw, which is given as Equation 4.

Rc=[(Yw*D/Rw)+1−D]R

Gc=[(Yw*D/Gw)+1−D]G

Bc=[(Yw*D/Bw)+1−D]B Equation 4

The dynamic adaptation unit 200 receives the adapted tristimulus response values (hereinafter referred to as “chromatic adaptation response values”) Rc, Gc, and Bc and generates a lightness adaptation value indicating a visual stimulus level perceived by a user who adapts to the lightness of surroundings. In this case, the dynamic adaptation unit 200 converts the chromatic adaptation response values Rc, Bc, and Gc to cone tristimulus response values R′, G′, and B′ of an equal area cone fundamental type. A variation of the cone tristimulus response value is given as Equation 5.

$$\begin{matrix}\vert \begin{matrix}{R}^{′} \\ {G}^{′} \\ {B}^{′}\end{matrix} \vert = {M}_{HPE} {M}_{CAT 02}^{- 1} \vert \begin{matrix}Rc \\ Gc \\ Bc\end{matrix} \vert \\ {M}_{HPE} = \vert \begin{matrix}0.38971 & 0.68898 & - 0.07868 \\ - 0.22981 & 1.18340 & 0.04641 \\ 0.000000 & 0.000000 & 1.000000\end{matrix} \vert \\ {M}_{CAT 02}^{- 1} = \vert \begin{matrix}1.096124 & - 0.278869 & 0.182745 \\ 0.454369 & 0.473533 & 0.072098 \\ - 0.009628 & - 0.005698 & 1.015326\end{matrix} \vert\end{matrix} \qquad Equation 5$$

The dynamic adaptation unit 200 compresses the cone tristimulus response values R′, G′, and B′ to generate lightness adaptation response values R′a, G′a, and B′a, which is given as Equation 6.

$$Rà = \frac{400 {( {F}_{L} R / 100 )}^{0.42}}{27.13 + {( {F}_{L} R / 100 )}^{0.42}} + 0.1 \\ Gà = \frac{400 {( {F}_{L} G / 100 )}^{0.42}}{27.13 + {( {F}_{L} G / 100 )}^{0.42}} + 0.1 \\ Bà = \frac{400 {( {F}_{L} B / 100 )}^{0.42}}{27.13 + {( {F}_{L} B / 100 )}^{0.42}} + 0.1 \qquad Equation 6$$

In this case, a luminance step adaptation coefficient F_{L} may be given as Equation 7 including the adapting field luminance L_{A}.

F_{L}=0.2k⁴(5L_{A})+0.1(1−k⁴)²(5L_{A})^{1/3} Equation 7

In this case, k is (1/(5L_{A}+1)).

The dynamic adaptation unit 200 calculates chroma contrast factors Nbb and Ncb that are luminance induction coefficients, an exponential factor z, and a factor n. Equations 8 to 10 calculate the respective factors.

n=Yb/Yw Equation 8

Nbb=Ncb=0.725(1/n)^{0.2} Equation 9

z=1.48+n^{0.5} Equation 10

The calculator 300 receives the lightness adaptation response values R′a, G′a, and B′a and lightness adaptation results including factors from the dynamic adaptation unit 200, and calculates information on color appearance of the color area according to the CIECAM02. The information on the color appearance includes lightness, brightness, chroma, colorfulness, color saturation, hue, and hue angle values of a color appearance model according to the CIECAM02.

According to the CIECAM02, the calculator 300 calculates a set of preliminary opponent dimensions a and b by using Equations 11 and 12.

a=[R′a+(B′a/11)]−(12G′a/11) Equation 11

b=(R′a+G′a−2B′a)/9 Equation 12

The calculator 300 calculates the hue angle h according to the set of preliminary opponent dimensions a and b in the CIECAM02 space by using Equation 13. Preliminary ab dimensions a and b are used to calculate the hue angle h. In addition, the calculator 300 calculates an eccentricity factor e by using Equation 14. The eccentricity factor e is used to adjust a size of the ab dimensions indicating a chroma compression difference around a hue circle.

$$\begin{matrix}h = {tan}^{- 1} ( b / a ) & Equation 13 \\ e = \frac{1}{4} [ cos ( h \frac{π}{180} + 2 ) + 3.8 ] & Equation 14\end{matrix}$$

The calculator 300 calculates an initial non-chroma response value A by a sum of non-linearly adapted cone response values modified to be the luminance induction coefficients Nbb, which is shown in Equation 14. In addition, the calculator 300 calculates lightness J by using a white to no-color response value Aw, a surroundings coefficient c, and an exponential factor z, which is shown in Equation 15.

A=[2R′a+G′a+( 1/20)B′a−0.305]Nbb Equation 15

J=100(A/Aw)^{cz} Equation 16

The calculator 300 calculates a brightness Q and a chroma C as given in Equations 17 and 18 according to the CIECAM02. In further detail, the calculator 300 uses the white to no-color response value Aw, the surroundings coefficient c, the lightness J, and the luminance step adaptation coefficient F_{L} to calculate the brightness Q, and uses the eccentricity factor e, color induction coefficients Nc and Ncb with respect to surroundings and background, the lightness J, and the factor n to calculate the chroma C.

Q=(4/c)(J/100)^{0.5}(A_{w}+4)F_{L}^{0.5} Equation 17

C=t^{0.9}(J/100)^{0.5}(1.64−0.29ⁿ)^{0.73} Equation 18

Here, a parameter t is given as Equation 19.

$$t = \frac{( 50000 / 13 ) {N}_{c} {N}_{cb} {e ( {a}^{2} + {b}^{2} )}^{1 / 2}}{Rà + Gà + ( 21 / 20 ) Bà} . \qquad Equation 19$$

In addition, the calculator 300 uses the chroma C and the luminance step adaptation coefficient F_{L} to calculate a colorfulness M, and uses the colorfulness M and the brightness Q to calculate a color saturation s as given in Equations 20 and 21.

M=CF_{L}^{0.25} Equation 20

s=100(M/Q)^{0.5} Equation 21

As described, the calculator 300 calculate the lightness J, the brightness Q, the chroma C, the color saturation s, the hue angle, and the colorfulness M according to the CIECAM02. The brightness Q indicates a level of the brightness. The colorfulness M indicates a level of the colorfulness. The lightness J is a brightness value determined with respect to a maximum value of the brightness. The chroma C is a colorfulness value determined with respect to the maximum value of the brightness. The hue angle h indicates an opponent color level with respect to reference chroma.

A method for evaluating image quality by the image quality evaluating device according to the exemplary embodiment of the present invention by using results output from the calculator 300 will now be described.

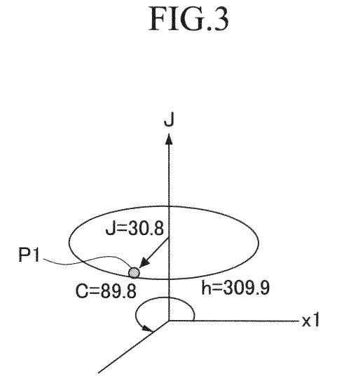

FIG. 2 is a diagram of the color appearance predictor 400 according to one exemplary embodiment of the present invention. The color appearance predictor 400 according to the exemplary embodiment of the present invention includes a color space realizing unit 410, a definition determining unit 420, a viewing angle characteristic determining unit 430, a gray level calculator 440, and a color difference calculator 450.

The color space realizing unit 410 uses a cylinder coordinate (hereinafter referred to as a “JCh coordinate”) realized by the lightness J, the chroma C, and the hue angle h to realize color stimulus of the color area. In addition, the color space realizing unit 410 uses another cylinder coordinate (hereinafter referred to as a “QMh coordinate”) realized by the brightness Q, the colorfulness M, and the hue angle h to display color stimulus of the color area.

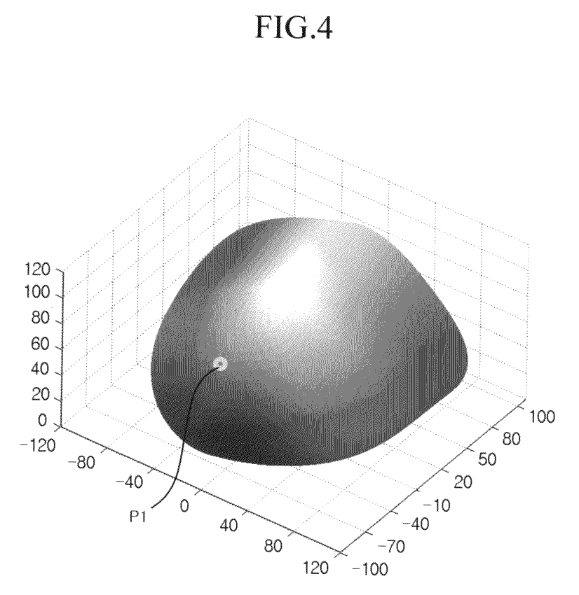

FIG. 3 is a diagram of a location corresponding to one color stimulus (X,Y,Z) in the JCh coordinate. For example, according to FIG. 3, the brightness is 30.8, the chroma C is 89.8, and the hue angle h is 309.9°.

As shown in FIG. 3, a position determined by rotating a reference line x1 with a radius of the chroma C by the hue angle h is moved in a perpendicular direction by the lightness J with respect to a plane including the position and the reference line x1 to mark a point P1 on the JCh coordinate. In a like manner, points for every color stimulus of the color area are positioned on the JCh coordinate to realize a color space corresponding to the color area.

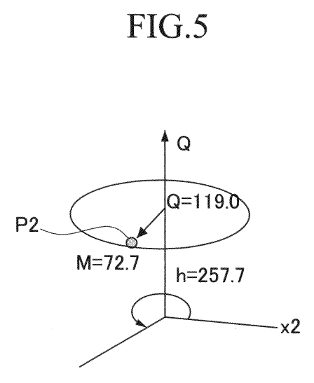

FIG. 4 is a diagram of the color space realized on the JCh coordinate.

A position of the point P1 on the color space is shown in FIG. 4.

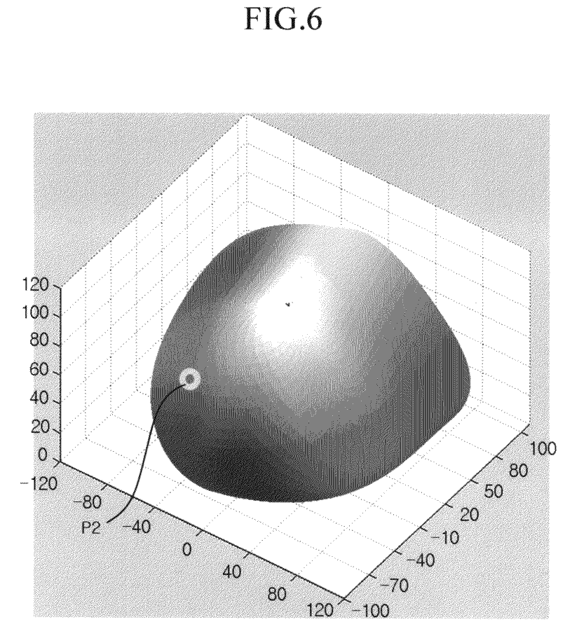

FIG. 5 is a diagram of a position corresponding to one color stimulus (X,Y,Z) in the QMh coordinate. For example, it is assumed that the brightness Q is 119.0, the colorfulness M is 72.7, and the hue angle h is 257.7°.

As shown in FIG. 5, a position determined by rotating a reference line x2 with a radius of the colorfulness M by the hue angle h is moved by the brightness Q in a perpendicular direction with respect to a plane including the position and the reference line x2 to mark a point P2 on the QMh coordinate. In a like manner, points for every color stimulus of the color area are positioned on the QMh coordinate to realize a color space corresponding to the color area.

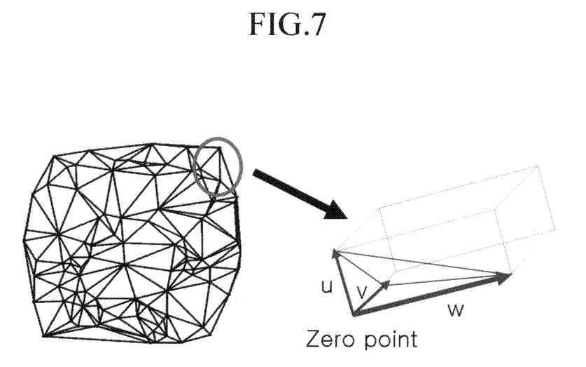

FIG. 6 is a diagram of the color space realized on the QMh coordinate.

The point P2 on the color space is shown in FIG. 6.

With respect to the tristimulus values X, Y, and Z of the same color stimulus, the color space realized by different coordinates is used to evaluate quality of various images.

The color space realizing unit 410 measures a volume of the color area, and a color reproduction level of the color area may be determined by the measured volume. Thereby, color reproduction capability of the image display device for displaying the color area may be determined.

The color space realizing unit 410 according to the exemplary embodiment of the present invention realizes the color space by a plurality of points corresponding to the grayscale of the image display device to measure the voltage of an actual color space. That is, a volume of the color space realized by 256 points is measured in a 256 grayscale image display device.

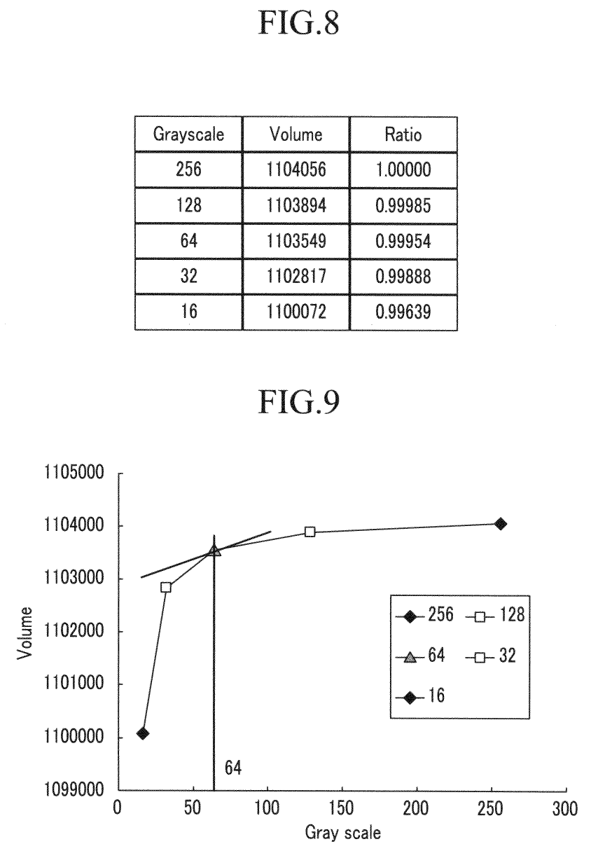

FIG. 7 is a diagram representing a method for calculating a color space volume.

The color space realizing unit 410 according to the exemplary embodiment of the present invention uses three-dimensional Delaunay tessellation to divide the color space into a plurality of triangular pyramids, and adds a volume of each triangular pyramid to calculate the color space volume. In further detail, as shown in FIG. 6, the color space realizing unit 410 establishes a zero point, forms a triangular pyramid by three points neighboring the zero point, and calculates a volume thereof. In addition, three triangular pyramids are formed by three respective points neighboring the above three points, and a volume thereof is calculated. When volumes of the formed triangular pyramids are added while the above method is repeatedly performed, the color space volume may be calculated. The triangular pyramid may be expressed by three vectors u, v, and w connected to the three points neighboring the zero point. The color space realizing unit 410 calculates a volume Vt of one triangular pyramid according to Equation 22, volumes of the calculated triangular pyramids are added according to Equation 23, and the color space volume may be calculated.

Vt=|(u×v)·w| Equation 22

V=ΣVt Equation 23

According to an experiment result, to realize the color space volume of 256 grayscale (i.e., grayscale having 256 gray levels), the color space volume realized by 64 points corresponding to at least 64 grayscale (i.e., grayscale having 64 gray levels) is measured. Thereby, a value converged to the color space volume of the 256 grayscale may be obtained. In further detail, the volume of the color space realized by 64 points corresponding to at least 64 grayscale is similar to the color space volume of 256 grayscale within a permissible error range, which may be varied according to a permissible error range in an experiment, and it is not limited thereto.

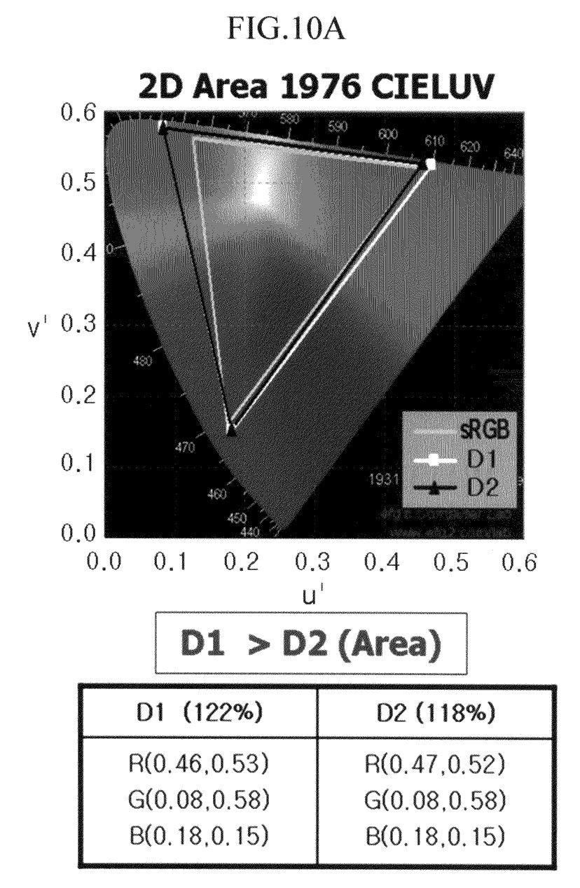

FIG. 8 is a table representing volumes of color spaces according to respective grayscales and a ratio between color space volumes of 256 grayscale. As shown in FIG. 8, the volume of 64 grayscale has a ratio of 0.99954 based on the volume of 256 grayscale.

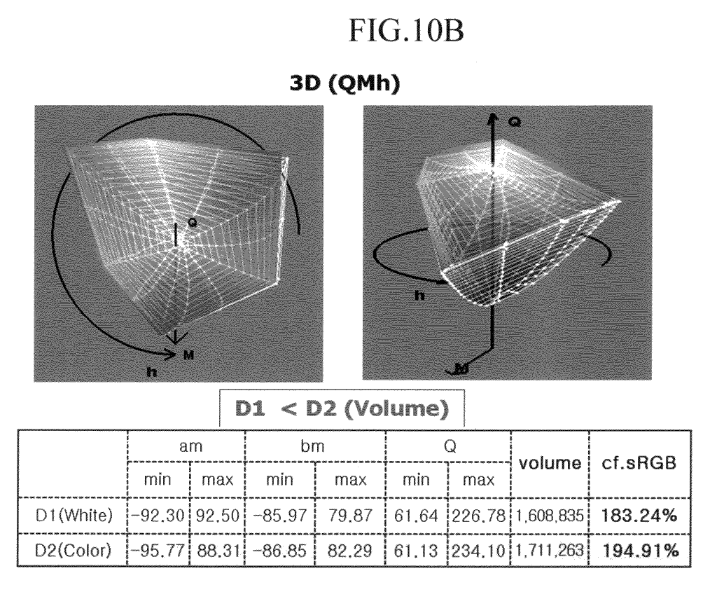

FIG. 9 is a graph representing results shown in FIG. 8.

In FIG. 9, it can be seen that a slope of the graph starts to become relatively gentle at the 64 grayscale. In one embodiment, the volume of the color space is calculated by more than ¼ gray levels of the total 256 gray levels of the image display device, but an error to the volume of the actual color space is within an allowable range. Coordinates of R, G, B, black, and white and a gamma value are randomly selected, and an intermediate value is calculated by an interpolating method to calculate the volume.

As described, the color space realizing unit 410 according to the exemplary embodiment of the present invention may calculate the color reproduction capability of the image display device by the color space volume. In addition, since the color space volume may be calculated based on data corresponding to grayscales that have less number of gray levels than the total number of gray levels of the image display device, a data processing amount of the image quality evaluating device 1 may decrease, and the processing speed may increase.

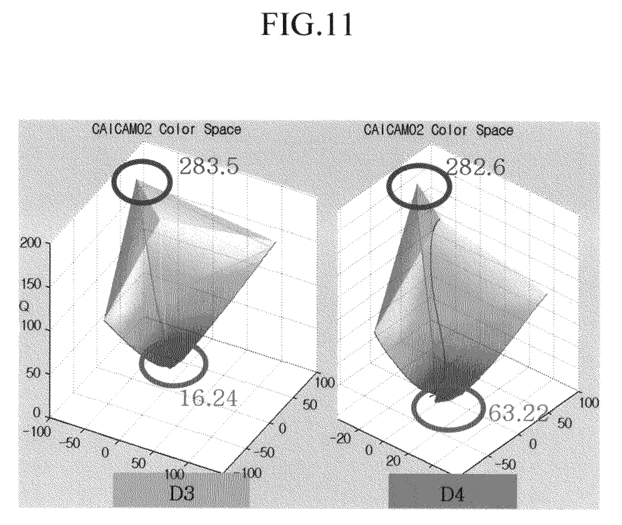

FIG. 10A shows a color area of a conventional two dimension plane, in which color areas of an image display device D1 and an image display device D2 according to the CIELUV suggested in 1976 are shown. The color area is the color reproduction capability of the respective image display devices. In FIG. 10A, a triangle color area of the image display device D1 bounded by white lines is greater than a triangle color area of the image display device D2 bounded by black lines. That is, the image display device D1 has greater color reproduction capability. sRGB is a standard color area defined by the ITU as broadcast color coordinates of HDTV for an NTSC mode television.

However, when it is difficult for a person to perceive a color of a color area realized by the image display device, the volume of the color appearance of the color area realized by the image display device is smaller. The image quality evaluating device according to the exemplary embodiment of the present invention may overcome the above limitation, as shown in FIG. 10B.

In FIG. 10B, the color space realizing unit 410 according to the exemplary embodiment of the present invention realizes the color space volumes of the image display devices D1 and D2 according to the QMh coordinate. A first parameter am and a second parameter bm in the table of FIG. 10B are respectively coordinate values in a color space determined according to the colorfulness M and the hue angle h received from the calculator 300. In further detail, the first parameter is obtained by multiplying the colorfulness M by a sine value (sin h) of a hue angle, and the second parameter is obtained by multiplying the colorfulness M by a cosine value (cos h) of the hue angle. In addition, min and max respectively denote minimum and maximum values of the first and second parameters and the brightness Q. cf.sRGB is values comparing respective color space volumes of the image display devices D1 and D2 to color space volume according to the sRGB.

As shown in FIG. 10B, differing from FIG. 10A, the volume of the white-lined color space of the image display device D1 is smaller than the volume of the color space of the image display device D2, which represents the color reproduction level of the image display device that is actually perceived by a person.

Color reproduction results are different between the two dimension color area and the three dimension color space as described because the color space according to the exemplary embodiment of the present invention reflects colors perceived by a person more accurately than the two dimension color area.

The definition determining unit 420 determines the clearness of the image display device by using a ratio of the maximum value and the minimum value of the brightness Q in the color space realized by the color space realizing unit 410. The clearness according to the exemplary embodiment of the present invention is determined according to a perceptual contrast. The perceptual contrast is defined as a ratio of brightness of a white level and brightness of a black level. In further detail, the brightness of the white level corresponds to the maximum value of the brightness Q, and the brightness of the black level corresponds to the minimum value of the brightness Q. The definition determining unit 420 calculates the perceptual contrast by dividing the maximum value by the minimum value of the brightness Q in the color space of the QMh coordinate.

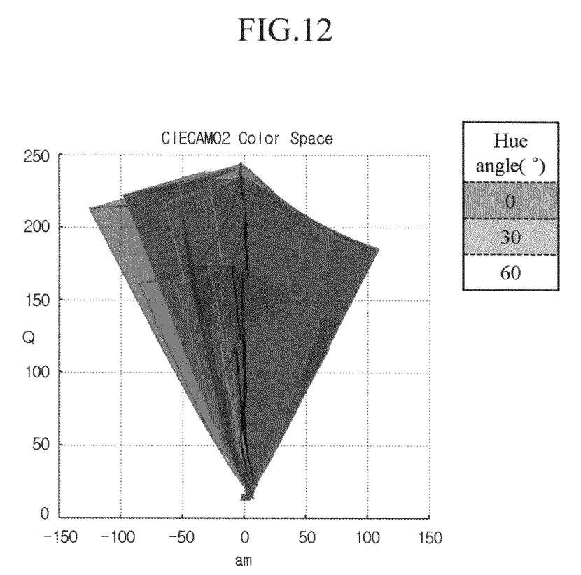

FIG. 11 shows color spaces of the QMh coordinate of image display devices D3 and D4 according to the exemplary embodiment of the present invention. As shown in FIG. 11, the maximum value of the brightness Q of the image display device D3 is 283.54, and the minimum value is 16.24. The maximum value of the brightness Q of the image display device D4 is 282.63, and the minimum value is 63.22. The perceptual contrast of the image display device D3 is 17.5, and the perceptual contrast of the image display device D4 is 4.5. That is, the image display device D3 provides a 3.9 times clearer image than the image display device D4.

The viewing angle characteristic determining unit 430 calculates the color space volume according to the hue angle in the color space to determine viewing angle characteristics of the image display device. In further detail, the viewing angle characteristic determining unit 430 calculates the color space volume according to the hue angle, and the calculated color space volume corresponds to the color reproduction capability. That is, the color space volume according to the hue angle is an index for representing the color reproduction capability of an image display device according to a viewing angle. As a result, the viewing angle characteristic determining unit 430 calculates the volume of the color space according to the hue angle to represent the color reproduction capability of the image display device.

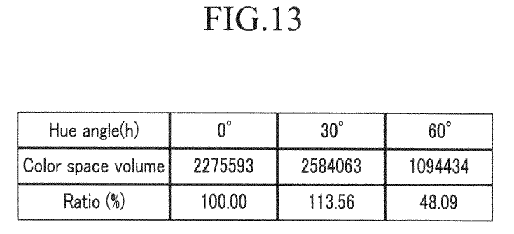

FIG. 12 is a diagram representing the color space volumes at hue angles of 0°, 30°, and 60° in the color space of the QMh coordinate by the viewing angle characteristic determining unit 430 according to the exemplary embodiment of the present invention. At the hue angle of 0°, a person views the image display device straight on. The hue angles of 30° and 60° are viewing angles at which a person view the image display device.

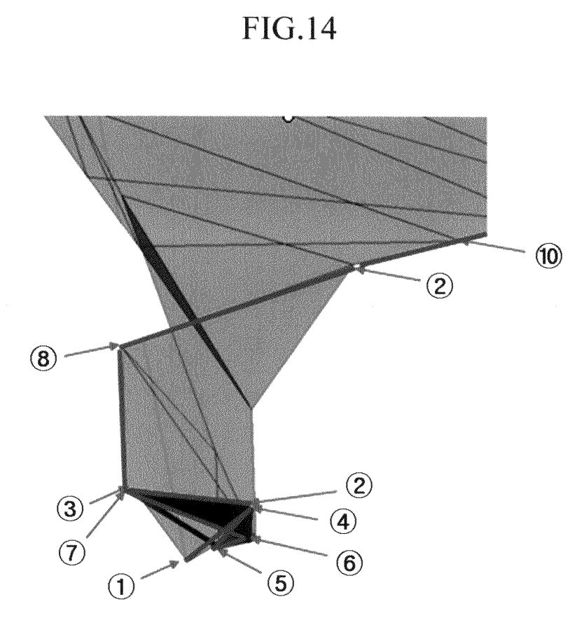

FIG. 13 is a table of the color space volumes in FIG. 12. The color space volume has different values at the hue angles of 0°, 30°, and 60°, and it has a maximum color space volume at the hue angle of 30°. That is, the color reproduction amount is maximized at the hue angle of 30°. In the table shown in FIG. 13, a ratio of the color space volume at a hue angle based on the color space volume of the hue angle of 0°.

The gray level calculator 440 detects a point of the color space with respect to the color stimulus in which the gray level is different in the color area to calculate the color appearance gray level for the color stimulus. Thereby, the gray level perceived by a person may be detected, which is referred to as the “color appearance gray level”. Important information for gamma correction for compensating the gray level of the image display device may be provided according to the color appearance gray level.

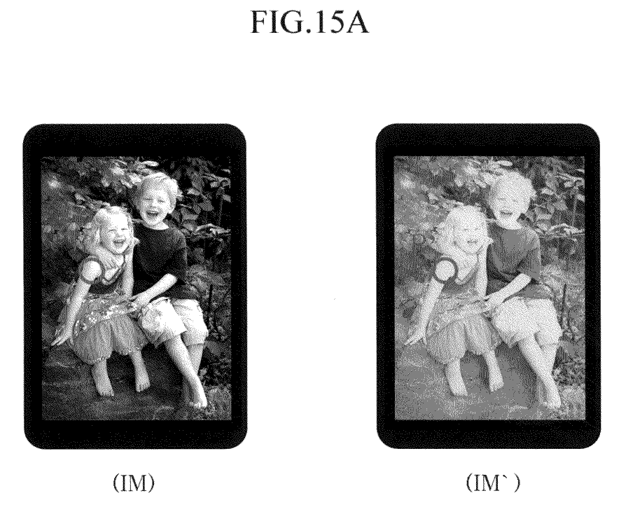

FIG. 14 is a diagram representing paths connecting detected points in the color space of the QMh coordinate. As shown in FIG. 14, the brightness Q does not increase in proportion to an increase of gray level, but varies in complicated paths, which shows instability of perceiving the gray level by a person.

The color difference calculator 450 calculates a color difference of the same image perceived by a person according to condition changes. The color difference calculator 450 adds the calculated color differences to obtain data for the color difference to be compensated according to the condition by the image display device for displaying the image.

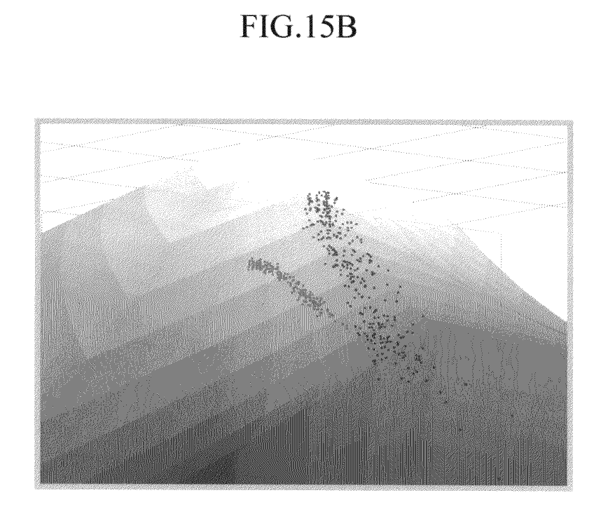

FIG. 15A shows images under different conditions. As shown in FIG. 15A, an image IM and an image IM′ are respectively images perceived under different conditions by a person.

FIG. 15B shows color distribution of a predetermined area in the color space of the QMh coordinate that is perceived under different conditions by a person. FIG. 15B is a diagram representing points corresponding to an area R of the image IM and an area R′ of the image IM′ in the color space of the QMh coordinate. A set of red points corresponds to the area R, and a set of violet points corresponds to the area R′.

For example, when the image IM is a color originally designed by the image display device and the image IM′ is a color perceived by a person, the color difference calculator 450 substrates a coordinate value of the red points and a coordinate value of the corresponding violet points.

As described, a color perceived by a person may vary in the same area of the same image according to the environment, and the image quality evaluating device according to the exemplary embodiment of the present invention may precisely calculate the differences.

According to the exemplary embodiment of the present invention, the image quality evaluating device for calculating data with respect to an image perceived by a person, and an image quality evaluating method, are provided.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. An image quality evaluating device for evaluating image quality of a color area by using a color appearance model, the image quality evaluating device comprising:
a chromatic adaptation unit for generating a chromatic adaptation result for the color area;
a dynamic adaptation unit for receiving the chromatic adaptation result and generating a lightness adaptation result with respect to the color area;
a calculator for using the lightness adaptation result to calculate information on color appearance of the color area; and
a color appearance predictor for using the information on the color appearance to realize a color space corresponding to the color area, calculating a volume of the color space, and calculating clearness of the color area, viewing angle characteristics, gray level characteristics, and color differences in the color space.

2. The image quality evaluating device of claim 1, wherein the information on the color appearance comprises brightness, colorfulness, and a hue angle of the color area.

3. The image quality evaluating device of claim 2, wherein the color appearance predictor comprises a color space realizing unit for forming a color space by moving a position by the brightness in a direction perpendicular to a plane including the position and a reference line, and calculating a volume of the color space, and
wherein the position is determined by rotating the reference line having a radius of the colorfulness by the hue angle.

4. The image quality evaluating device of claim 3, wherein the color space realizing unit adds respective volumes of a plurality of triangular pyramids to calculate a volume of the color space, and
wherein each triangular pyramid includes three points that are closest to a point of the color space and the point.

5. The image quality evaluating device of claim 4, wherein a number of points used to determine the volume of the color space is at least ¼ of all the points forming the color space.

6. The image quality evaluating device of claim 3, wherein the color appearance predictor further comprises a definition determining unit for calculating a ratio of a maximum value and a minimum value of the brightness in the color space and calculating clearness of the color area according to the calculated ratio.

7. The image quality evaluating device of claim 6, wherein the maximum value corresponds to a brightness of a white level, and the minimum value corresponds to a brightness of a black level.

8. The image quality evaluating device of claim 3, wherein the color appearance predictor further comprises a viewing angle characteristic determining unit for calculating the color space volume according to the hue angle, and calculating viewing angle characteristics of the color area.

9. The image quality evaluating device of claim 3, wherein the color appearance predictor further comprises a gray level calculator for detecting a plurality of points of the color area with respect to a plurality of color stimulus values in which gray levels are different in the color area, and generating paths connecting the plurality of points according to gray level variations.

10. The image quality evaluating device of claim 3, wherein the color appearance predictor further comprises a color difference calculator for diversifying an externally exposed condition of the color area to detect a plurality of points of the color space corresponding to an object area of the color area, and calculating a color difference according to an externally exposed condition of the object area.

11. An image quality evaluating method using a color appearance model to evaluate image quality of a color area, the image quality evaluating method comprising:
generating a chromatic adaptation result with respect to the color area;
receiving the chromatic adaptation result and generating a lightness adaptation result with respect to the color area;
using the lightness adaptation result to calculate information on color appearance of the color area; and
generating color appearance characteristics by using the information on the color appearance to realize a color space corresponding to the color area, calculating a volume of the color space, and calculating clearness of the color area, viewing angle characteristics, gray level characteristics, and color differences in the color space.

12. The image quality evaluating method of claim 11, wherein the information on the color appearance comprises brightness, colorfulness, and a hue angle of the color area.

13. The image quality evaluating method of claim 12, wherein the generating of the color appearance characteristics comprises forming a color space by moving a position by the brightness in a direction perpendicular to a plane including the position and a reference line, and calculating a volume of the color space, and
wherein the position is determined by rotating the reference line having a radius of the colorfulness by the hue angle.

14. The image quality evaluating method of claim 13, wherein the calculating of the volume of the color space comprises adding respective volumes of a plurality of triangular pyramids to calculate a volume of the color space, and
wherein each triangular pyramid includes three points that are closest to a point of the color space and the point.

15. The image quality evaluating method of claim 14, wherein a number of points to measure the volume of the color space is at least ¼ of all the points forming the color space.

16. The image quality evaluating method of claim 13, wherein the generating of the color appearance characteristics further comprises calculating a ratio of a maximum value and a minimum value of the brightness in the color space and calculating clearness of the color area according to the calculated ratio.

17. The image quality evaluating method of claim 16, wherein the maximum value corresponds to a brightness of a white level, and the minimum value corresponds to a brightness of a black level.

18. The image quality evaluating method of claim 13, wherein the generating of the color appearance characteristics further comprises calculating the color space volume according to the hue angle, and calculating viewing angle characteristics of the color area.

19. The image quality evaluating method of claim 13, wherein the generating of the color appearance characteristics further comprises detecting a plurality of points of the color area with respect to a plurality of color stimulus values in which gray levels are different in the color area, and generating paths connecting the plurality of points according to gray level variations.

20. The image quality evaluating method of claim 13, wherein the generating of the color appearance characteristics further comprises diversifying an externally exposed condition of the color area to detect a plurality of points of the color space corresponding to an object area of the color area, and calculating a color difference according to an externally exposed condition of the object area.
